(19) United States
(12) Patent Application Publication
(10) Pub. No.: US 2012/0001065 A1
(43) Pub. Date: Jan. 5, 2012

(54) EVALUATING RENAL FUNCTION

(75) Inventors: Jesse C. Seegmiller, Rochester, MN (US); John C. Lieske, Rochester, MN (US); Timothy S. Larson, Rochester, MN (US); Bradley E. Burns, Stewartville, MN (US)

(73) Assignee: Mayo Foundation for Medical Education and Rsearch, Rochester, MN (US)

(21) Appl. No.: 13/256,121

(22) PCT Filed: Mar. 12, 2010
(86) PCT No.: PCT/US10/27110

§ 371 Date: Sep. 12, 2011

Related U.S. Application Data
(60) Provisional application No. 61/161,198, filed on Mar. 18, 2009.

(51) Int. Cl. H01J 49/26

(52) U.S. Cl. 250/282

(57) ABSTRACT

This document relates to methods and materials involved in evaluating renal function in a subject. For example, methods and materials for evaluating renal clearance using mass spectrometry techniques are provided.

### CROSS-REFERENCE TO RELATED APPLICATION

This application is based on, and claims the benefit of, U.S. Provisional Application No. 61/161,198 filed on Mar. 18, 2009, which is incorporated by reference herein in its entirety.

### BACKGROUND

1. Technical Field

This document relates to methods and materials involved in evaluating renal function in a mammal. For example, this document provides methods and materials for evaluating renal clearance using mass spectrometry techniques.

2. Background Information

Renal disorders encompass a variety of conditions and diseases such as kidney failure, chronic kidney disease, acute kidney injury, polycystic kidney disease, and lupus nephritis. Renal disorders are often associated with other chronic conditions including hypertension, cardiovascular disease, and diabetes. Indeed, diabetes is the most common cause of end-stage kidney disease in the United States. Assessment of several variables including effective renal plasma flow (ERPF), glomerular filtration rate (GFR), renal tubular epithelial cell solute and water transport, and hormonal release provide a measure of renal function in healthy and diseased kidneys. Renal function can be assessed to determine the onset, severity, and progression of kidney disease, as well as to monitor the efficacy of various treatment regimens and to optimize patient care.

### SUMMARY

This document relates to methods and materials involved in evaluating renal function in a mammal. For example, this document provides methods of detecting iothalamate and p-aminohippuric acid (PAH) using mass spectrometry to determine the GFR and ERPF, respectively. The methods provided herein can be used to detect iothalamate and PAH in a sample obtained from a mammal (e.g., a urine sample obtained from a mammal). In some cases, the methods and materials provided herein can include isotopically labeled internal standards that elute simultaneously with the molecules of interest, thereby providing an effective manner for measuring their concentrations and calculating renal clearance in order to determine GFR and/or ERPF. The methods and materials provided herein can allow a clinician or other professional to quantitate both iothalamate and PAH concentrations in a single reaction sample rather than splitting the sample to be run on two separate methods, thereby reducing the potential for interference.

In general, one aspect of this document features a method of evaluating renal function in a mammal. The method comprises, or consists essentially of, detecting the level of iothalamate or p-aminohippuric acid (PAH) in a sample obtained from said mammal using a mass spectrometry technique. The mammal can be a human. The sample can be plasma. The sample can be urine. An internal standard can be added to the sample prior to the detecting step. The internal standard can be an isotopically-labeled iothalamate or PAH. The detecting step can comprise (a) ionizing said sample to generate ions; (b) selecting parent ions; (c) fragmenting to produce daughter ions; and (d) detecting one or both of iothalamate or p-aminohippuric acid in the sample by detecting one or both of a daughter ion signal unique to iothalamate or p-aminohippuric acid.

In another aspect, this document features a method for determining renal clearance in a mammal. The method comprises, or consists essentially of, comparing levels of iothalamate or p-aminohippuric acid (PAH) in a sample obtained from a mammal, wherein the levels were measured by a mass spectrometry technique. Iothalamate or PAH can be administered to the mammal. The method can include measuring iothalamate or PAH in said sample using the mass spectrometry technique. Renal clearance can be determined using measurements of iothalamate or PAH in the sample.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 contains the results of capillary electrophoresis with ultraviolet (UV) detection. The first peak corresponds to the internal standard. The second peak corresponds to iothalamate (UV detection at 254 nm). The glomerular filtration rate (GFR) can be calculated based upon the ratio of the blood and urine concentrations of iothalamate (as depicted here). Peak A denotes elution of the surrogate internal standard phenyl phosphate and peak B corresponds to iothalamate.

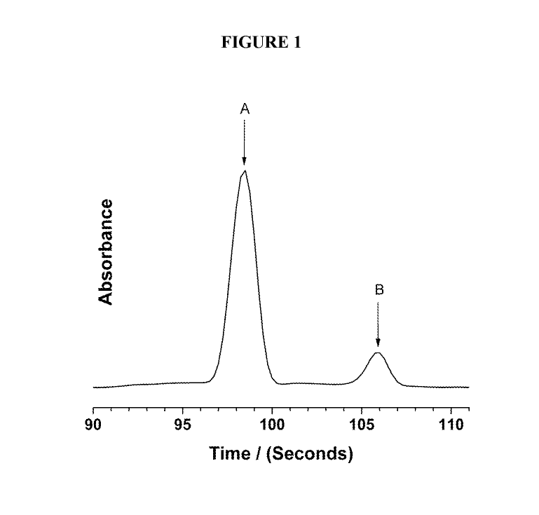

FIG. 2 contains the results of capillary electrophoresis with ultraviolet (UV) detection. The first peak (A) corresponds to the surrogate internal standard. The second peak (B) corresponds to iothalamate (UV detection at 254 nm). In the presence of interfering substances, an additional peak (C) is observed, as was the case in this sample. Such interference confounds accurate calculation of the patient's GFR.

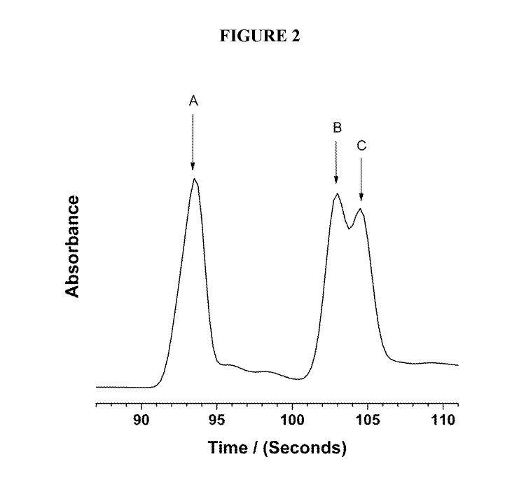

FIG. 3 is a LC-MS/MS chromatogram of the same sample showing that the unknown interference does not confound results associated with the LC-MS/MS method.

FIG. 4 is a chromatogram representing the results of tandem mass spectrometry of iothalamate and PAH in a single analysis. The first peak corresponds to iothalamate and the second peak corresponds to PAH.

### DETAILED DESCRIPTION

This document provides methods and materials for evaluating renal function in a mammal using mass spectrometry techniques (e.g., tandem mass spectrometry techniques). For example, this document provides methods and materials for detecting iothalamate and PAH in a sample obtained from a mammal using tandem mass spectrometry.

The methods and materials provided herein can be used to evaluate renal function by simultaneously detecting iothalamate and PAH in a sample using mass spectrometry. Mass spectrometry analysis can be conducted with a single mass analyzer (MS) or a “tandem in space” analyzer such as a triple quadrupole tandem mass spectrometer (MS/MS). Any appropriate tandem mass spectrometry techniques can be used. In some cases, liquid chromatography tandem mass spectrometry (LC-MS/MS) methods can be used. For example, tandem mass spectrometry can include the steps of (a) ionizing a sample to generate ions; (b) selecting parent ions unique to iothalamate and/or PAH; (c) fragmenting to produce daughter ions; and (d) detecting iothalamate or PAH in the sample by detecting one or both daughter ions unique to iothalamate or PAH. Any tandem mass spectrometry machine or LC-MS/MS machine can be used, including the API 4000 triple quadrupole tandem mass spectrometer (ABI-SCIEX, Toronto, Canada). In some cases, tandem mass spectrometry can be performed using an Applied Biosystems API 5000 MS/MS system. Exemplary tandem mass spectrometers are available from: Waters Corporation, Thermoelectron, and Sciex. The most commonly used tandem mass spectrometers are electrospray triple quadrupoles. Software for tuning, selecting, and optimizing ion pairs is also available, e.g., Analyst Software Ver. 1.4 (ABI-SCIEX).

Analytes can be multiplexed for simultaneous detection as described herein. For example, analytes can be identified based on chromatographic retention time and sensing mass-specific transitions using multiple reaction monitoring (MRM). In MRM, a parent ion of interest is selected in MS-1, fragmented in the collision cell and a specific fragment ion resulting from the collisional activation is selected in MS-2 and finally detected. MS-1 and MS-2 are fixed to respectively select the corresponding parent and fragment ion pairs of interest for a predetermined amount of time (e.g., a few milliseconds). This specific parent ion-product ion transition can be considered as one detection channel. If additional analytes are to be detected, additional detection channels with specific mass transitions can be introduced in the experiment. Data from all selected mass transitions (channels) can be acquired sequentially to obtain the desired information.

In some cases, evaluation of renal function, including GFR and ERPF, can include detecting renal clearance of iothalamate and/or PAH in a sample following administration of iothalamate and/or PAH to a mammal. For example, in GFR determinations, iothalamate can be administered subcutaneously, or continuously infused intravenously by bolus or continuous infusion into a mammal. Dose administration depends upon the mammal size and the following dosing schemes have been developed for use in humans. For the subcutaneous injection (determination of GFR only) of iothalamate, (1) 1 mL of Conray 60® 300 mg/0.5 mL plus 0.5 mL sterile water for injection can be administered subcutaneously once for mammals greater than 40 kg; (2) 0.5 mL of Conray 60® 150 mg/0.25 mL plus 0.25 mL sterile water for injection can be administered subcutaneously once for mammals greater than 10 kg but less than or equal to 40 kg; (3) 0.2 mL of Conray 60® 60 mg/0.1 mL plus 0.1 mL sterile water for injection can be administered subcutaneously once for mammals less than 10 kg or administered by constant infusion administration.

For the constant infusion (Standard Renal Clearance) of iothalamate and PAH the dosing protocol can be the following: (1) a 20 mL intravenous bolus of a priming solution can be initially administered where the mL of a PAH stock solution (0.2 g/mL) is equal to (0.05 mL/kg)×(body weight in kg)=mL of PAH Stock, where the bolus can also contain iothalamate, derived from a stock solution of 0.6 g/mL, that can be dosed using (0.0053 mL/kg)×(body weight in kg)=mL of iothalamate stock, and where a 0.45% NaCl saline solution is used to dilute the final volume to 20 mL; (2) a 200 mL 0.45% NaCl saline intravenous sustaining solution can be administered at a flow rate of 1 mL/minute containing (15 mL)×(% eGFR derived from creatinine)=mL of PAH stock, and (0.27 mL)×(% eGFR)=mL of iothalamate stock.

In some cases, iothalamate and PAH can be administered to the mammal by intravenous injection. Any appropriate sample can be used to detect clearance of iothalamate and PAH. For example, samples can be biological fluids (e.g., urine, blood, plasma, serum, saliva, semen, sputum, cerebral spinal fluid, tears, or mucus) or other biological samples. A sample can be, for example, a specimen obtained from a mammal. Exemplary mammals for the methods and materials described herein are humans. Other mammals suitable for the methods provided herein can include non-human primates, pigs, dogs, cats, and rabbits. Samples can be used immediately following collection from the mammal, or samples can be frozen, refrigerated, or otherwise stored for later use.

In some cases, a sample can be processed to reduce the presence of interfering substances. For example, prior to performing mass spectrometry, a sample can be extracted using an extraction solution. Any appropriate method of polypeptide extraction or precipitation can be performed to deplete high abundance and high molecular weight polypeptides from a biological sample (e.g., plasma, urine) prior to mass spectrometric analysis. For example, acetonitrile polypeptide extraction/precipitation can be performed. In some cases, immunochemistry-based protein-depletion techniques can be performed to remove high abundance proteins from a biological sample. For example, commercially-available kits such as the ProteoPrep® 20 (Sigma-Aldrich) plasma immunodepletion kit can be used to deplete high abundance proteins from plasma.

In some cases, one or more internal standards can be added at known concentrations to a sample to allow for quantitation of iothalamate and/or PAH. For example, for a sample analyzed using tandem mass spectrometry, the ratio of the signals produced by iothalamate, PAH, and their corresponding internal standards (e.g., D₃-iothalamate, D₄-PAH) can be used to determine the amounts of each compound in the sample. In some cases, internal standards can be prepared in an extraction solution prior to mixing a sample (e.g., a plasma or urine sample) with the extraction solution. Internal standards for a molecule detected by a method described herein can be any modification or analog of a molecule that is detectable by mass spectrometry. For example, commonly used internal standards for mass spectrometry are isotopically-labeled forms or chemical derivatives of a molecule. Labels can be ²H (D), ¹⁵N, ¹³C, or ¹⁸O in any combination thereof. In some cases, an internal standard for iothalamate can be D₃-iothalamate, and an internal standard for PAH can be D₄-PAH.

Any appropriate method can be used to convert iothalamate and/or PAH concentration data collected by LC-MS/MS into renal clearance information. For example, GFR can be calculated according to Formula I.

$$Iothalamate\_Clearance = GFR = \frac{Rate\_of \_excretion \_of \_iothalamate}{Plasma\_concentration \_of \_iothalamate} = \frac{{U}_{Ioth} \times V}{{P}_{Ioth}} \qquad ( I )$$

where U_{Ioth} is the concentration of iothalamate in urine, V is the urine flow rate (volume per unit of time), and P_{Ioth} is the plasma concentration during the urine collection period.

ERPF can be calculated according to Formula II.

$$PAH\_Clearance = ERPF = \frac{Rate\_of \_excretion \_of \_PAH}{Plasma\_concentration \_of \_PAH} = \frac{{U}_{PAH} \times V}{{P}_{PAH}} \qquad ( II )$$

where U_{PAH} is the concentration of PAH in urine, V is urine flow rate (volume per unit of time), and P_{PAH} is the plasma concentration during the urine collection period.

From the GFR and ERPF one can then calculate the filtration fraction percentage (FF %) according to Formula III.

$$FF ( \% ) = \frac{GFR \times 100}{ERPF} \qquad ( III )$$

Information collected according to the methods provided herein can be used to assess the health state of a mammal (e.g., a human patient), such as presence or absence of a disorder (e.g., renal disease) or to evaluate risk of developing such a disorder. In some cases, such information can be used for determining therapeutic efficacy of a particular treatment regimen. For example, changes in renal clearance in a mammal can indicate the mammal's positive or negative response to a particular treatment regimen. In some cases, renal function information collected according to the methods provided herein can be used for monitoring the health state of a mammal (e.g., a human patient), such as improvement of disorder (e.g., renal disease). For example, positive changes in renal clearance in a mammal over a period of time can indicate improvement in the mammal's renal disorder. In some cases, information collected according to the methods described herein can be used to evaluate changes in renal function in a subject at risk for developing a disorder such as renal disease. Such subjects can include those who have (i) a genetic predisposition for a disorder such as renal disease, or (ii) one or more risk factors for developing a disorder such as renal disease.

Information collected according to the methods provided herein can be communicated to another person. For example, a researcher or diagnostician can communicate such information to a clinician or other medical professional. After such information is communicated, a medical professional can take one or more actions that can affect patient care. For example, a medical professional can record information in the patient's medical record regarding the risk of the patient to develop a renal disease. In some cases, a medical professional can record information regarding risk assessment, or otherwise transform the patient's medical record, to reflect the patient's current medical condition. In some cases, a medical professional can review and evaluate a patient's entire medical record and assess multiple treatment strategies for clinical intervention of a patient's condition. In some cases, a medical professional can initiate or modify treatment after receiving renal function information. In some cases, a medical professional can recommend a change in therapy. In some cases, a medical professional can enroll a patient in a clinical trial for, by way of example, evaluating changes in renal function in a subject having or at risk for developing a disorder such as renal disease as described above.

Any appropriate method can be used to communicate renal function information to another person (e.g., a professional), and information can be communicated directly or indirectly. For example, a laboratory technician can input renal function information into a computer-based record. In some cases, information can be communicated by making an physical alteration to medical or research records. For example, a medical professional can make a permanent notation or flag a medical record for communicating a diagnosis to other health-care professionals reviewing the record. In some cases, a medical professional can provide a copy of a patient's medical records to a specialist. Any type of communication can be used (e.g., mail, e-mail, telephone, and face-to-face interactions). Information also can be communicated to a professional by making that information electronically available to the professional. For example, information can be placed on a computer database such that a health-care professional can access the information. In addition, information can be communicated to a hospital, clinic, or research facility serving as an agent for the professional.

The invention will be further described in the following examples, which do not limit the scope of the invention described in the claims.

### EXAMPLES

### Example 1

### LC-MS/MS Method of Evaluating Renal Function

For GFR determinations only (Short Renal Clearance), iothalamate (Conray®, Mallinckrodt Inc. St. Louis, Mo.) was administered subcutaneously to 10 human subjects. Iothalamate was administered at appropriate concentrations using the formulary provided above according to each subject's body weight, where timed blood and urine samples were collected from the 10 subjects hours following iothalamate administration. Blood samples were collected in tubes containing heparin or EDTA. Blood samples were centrifuged at 650 g for 7 minutes to separate plasma. Plasma was collected and stored at 4° C. to 8° C. until analysis. Urine samples were collected and stored at 4° C. to 8° C. until analysis. Frozen plasma and urine samples were thawed and stored at 4° C. to 8° C. until analysis.

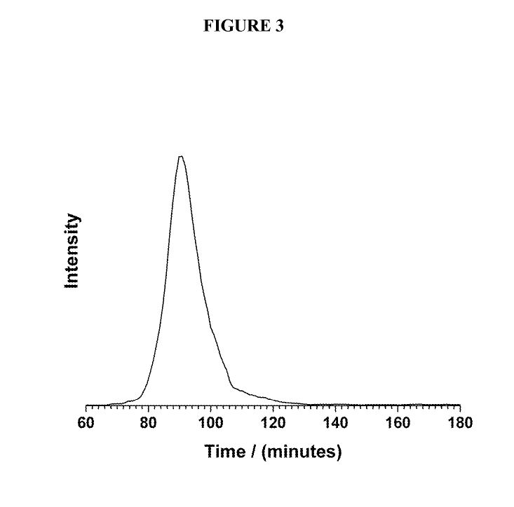

The timed plasma collections P1 and P2 (50 μL of each) were then pooled and spiked with internal standard, D₃-iothalamate (20 μL of 38 μg/mL stock). Whereas the urine samples were diluted 1:10 with water and followed by the addition of internal standard, D₃-iothalamate. All urine and plasma samples were then subjected to acetonitrile and/or 70% acetone polypeptide precipitation (100 μL) followed by centrifugation for 5 minutes at 650 g to remove/pellet protein. Supernatant from the protein precipitation was then diluted 1:50 in water and was then suitable for analysis by liquid chromatography tandem mass spectrometry (LC-MS/MS). LC-MS/MS was performed using the API 5000™ LC-MS/MS system (Applied Biosystems). The results of the tandem mass spectrometry assay are presented in FIG. 3. The first peak corresponds to iothalamate. The second peak corresponds to PAH. As demonstrated in FIG. 3, the internal standards eluted simultaneously with the molecules of interest.

For the simultaneous determination of GFR and ERPF, iothalamate (Conray®, Mallinckrodt Inc. St. Louis, Mo.) and PAH (Aminohippurate Sodium, Merck & Co. Inc. Whitehouse Station, N.J.) were administered intravenously to one human subject. Iothalamate and PAH were administered using previously described constant infusion protocol. Timed blood and urine samples were collected from the subject following iothalamate and/or PAH administration. Blood samples were collected in tubes containing heparin or EDTA. Blood samples were centrifuged at 650 g for 7 minutes to separate plasma. Plasma was collected and stored at 4° C. to 8° C. Urine samples were collected and stored at 4° C. to 8° C. Frozen plasma and urine samples were thawed and stored at 4° C. to 8° C. until analysis.

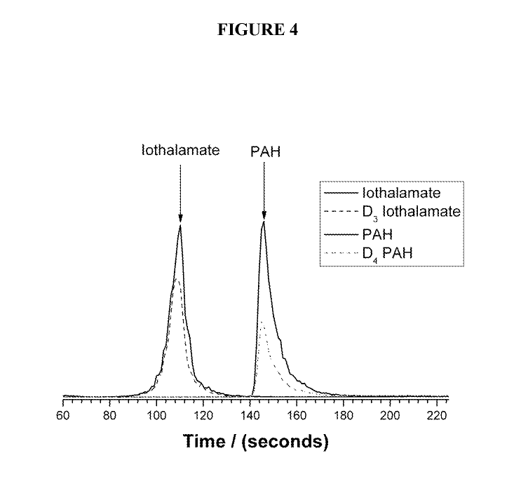

The timed plasma collections (100 μL of each) were processed independently by diluting 1:3 with water followed by the addition of internal standard, D₃-iothalamate and D₄-PAH (20 μL of 38 μg/mL stock). The urine samples were diluted 1:10 with water and followed by the addition of internal standard, D₃-iothalamate. All urine and plasma samples were then subjected to acetonitrile and/or 70% acetone polypeptide precipitation (100 μL) followed by centrifugation for 5 minutes at 650 g to remove/pellet protein. Supernatant from the protein precipitation was then diluted 1:50 in water and was then suitable for analysis by liquid chromatography tandem mass spectrometry (LC-MS/MS). LC-MS/MS was performed using the API 5000™ LC-MS/MS system (Applied Biosystems). The results of the tandem mass spectrometry assay are presented in FIG. 4.

Comparison of results obtained by capillary electrophoresis/UV detection method (CE-UV) and tandem mass method (LC-MS/MS) revealed a strong correlation between the two methods for iothalamate concentration and corrected GFR (Table 1). LC-MS/MS was more sensitive than CE-UV and less susceptible to interfering substances. Data in Table 1 also demonstrate that the CE-UV method yields higher values than the LC-MS/MS method, which may be indicative of qualitative inaccuracies caused by the presence of interfering compounds in the standard method. Comparison of results obtained from continuous infusion of iothalamate and PAH also revealed a strong correlation between the two methods for iothalamate concentration, PAH concentration, and corrected GFR and ERPF-long renal clearance (Table 2A and Table 2B).

TABLE 1
GFR-Short Renal Clearance (Subcutaneous Iothalamate Injection Only)

| P1/P2 | | | | | | | U1 | | | |
|---|---|---|---|---|---|---|---|---|---|---|
| | CE | MS | % | CE | MS | % | | CE | MS | % |
| | μg/mL | μg/mL | diff. | GFR | GFR | diff. | | μg/mL | μg/mL | diff. |
| 1 | 15.205 | 13.8 | 9.24% | 18 | 19 | −5.56% | 1 | 6.235 | 5.83 | 6.50% |
| 2 | 11.153 | 11.2 | −0.42% | 39 | 39 | 0.00% | 2 | 4.032 | 4.07 | −0.94% |
| 3 | 14.456 | 13.1 | 9.38% | 64 | 63 | 1.56% | 3 | 13.733 | 12.2 | 11.16% |
| 4 | 10.439 | 9.57 | 8.32% | 30 | 29 | 3.33% | 4 | 26.594 | 23.8 | 10.51% |
| 5 | 7.545 | 6.01 | 20.34% | 57 | 64 | −12.28% | 5 | 15.176 | 13.7 | 9.73% |
| 6 | 10.364 | 9.28 | 10.46% | 27 | 25 | 7.41% | 6 | 5.209 | 4.42 | 15.15% |
| 7 | 18.338 | 17.6 | 4.02% | 15 | 15 | 0.00% | 7 | 9.152 | 8.71 | 4.83% |
| 8 | 8.892 | 7.81 | 12.17% | 4 | 4 | 0.00% | 8 | 5.675 | 5.37 | 5.37% |
| 9 | 12.104 | 10.5 | 13.25% | 41 | 41 | 0.00% | 9 | 6.695 | 5.78 | 13.67% |
| 10 | 15.607 | 14.2 | 9.02% | 18 | 18 | 0.00% | 10 | 28.492 | 25.1 | 11.91% |

| | | |
|---|---|---|
| Avg. = 9.58% | Avg. = −0.55% | Avg. = 8.79% |

TABLE 2A
Iothalamate Concentration Comparison From GFR and ERPF-Long
Renal Clearance (Iothalamate and PAH Continuous Infusion)

| Plasma | | | | | | | Urine | | | |
|---|---|---|---|---|---|---|---|---|---|---|
| | CE | MS | % | CE | MS | % | | CE | MS | % |
| | μg/mL | μg/mL | diff. | GFR | GFR | diff. | | μg/mL | μg/mL | diff. |
| P1 | 11.645 | 10.6 | 8.97% | 138 | 141 | −2.54% | U1 | 12.973 | 12.4 | 4.42% |
| P2 | 9.479 | 9.09 | 4.10% | 127 | 114 | 10.56% | U2 | 9.189 | 7.85 | 14.57% |
| P3 | 8.341 | 7.93 | 4.93% | 123 | 120 | 2.63% | U3 | 8.069 | 8.09 | −0.26% |
| P4 | 7.334 | 8.21 | −11.94% | 114 | 116 | −2.06% | U4 | 7.716 | 8.5 | −10.16% |
| P5 | 6.869 | 7.12 | −3.65% | 119 | 119 | 0.00% | U5 | 7.333 | 7.21 | 1.68% |

| | | | | | |
|---|---|---|---|---|---|
| P6 | 6.912 | 6.43 | 6.97% | Avg. = 4.40% | Avg. = 2.05% |

Avg. = 1.56%

TABLE 2B
PAH Concentration Comparison From GFR and ERPF-Long Renal
Clearance (Iothalamate and PAH Continuous Infusion)

| Plasma | | | | | | | Urine | | | |
|---|---|---|---|---|---|---|---|---|---|---|
| | CE | MS | % | CE | MS | % | | CE | MS | % |
| | μg/mL | μg/mL | diff. | ERPF | ERPF | diff. | | μg/mL | μg/mL | diff. |
| P1 | 18.000 | 19.4 | −7.78% | 615 | 602 | 2.10% | U1 | 97.620 | 100 | −2.44% |
| P2 | 17.635 | 17.9 | −1.50% | 543 | 566 | −4.30% | U2 | 77.770 | 82.9 | −6.60% |
| P3 | 17.755 | 18.3 | −3.07% | 574 | 586 | −2.08% | U3 | 83.570 | 88.7 | −6.14% |
| P4 | 17.120 | 18 | −5.14% | 534 | 514 | 3.75% | U4 | 88.960 | 90 | −1.17% |
| P5 | 17.740 | 18.7 | −5.41% | 523 | 532 | −1.76% | U5 | 84.520 | 89.5 | −5.89% |

| | | | | | |
|---|---|---|---|---|---|
| P6 | 18.320 | 18.9 | −3.17% | Avg. = −2.71% | Avg. = −4.45% |

Avg. = −4.34%

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of evaluating renal function in a mammal, comprising detecting the level of iothalamate or p-aminohippuric acid in a sample obtained from said mammal using a mass spectrometry technique.

2. The method of claim 1, wherein said mammal is a human.

3. The method of claim 1, wherein said sample is plasma.

4. The method of claim 1, wherein said sample is urine.

5. The method of claim 1, wherein an internal standard is added to said sample prior to said detecting.

6. The method of claim 5, wherein said internal standard comprises an isotopically-labeled iothalamate or PAH.

7. The method of claim 1, wherein said detecting comprises (a) ionizing said sample to generate ions; (b) selecting parent ions; (c) fragmenting to produce daughter ions; and (d) detecting one or both of said iothalamate or said p-aminohippuric acid in said sample by detecting one or both of a daughter ion signal unique to said iothalamate or said p-aminohippuric acid.

8. A method of determining renal clearance in a mammal, comprising comparing levels of iothalamate or p-aminohippuric acid in a sample obtained from said mammal, wherein said levels were measured by a mass spectrometry technique.

9. The method of claim 8, wherein iothalamate or PAH is administered to said mammal.

10. The method of claim 8, wherein said method comprises measuring iothalamate or PAH in said sample using said mass spectrometry technique.

11. The method of claim 10, wherein renal clearance is determined using said measurements of iothalamate or PAH in said sample.
